(19) United States
(12) Patent Application Publication
(10) Pub. No.: US 2025/0075758 A1
(43) Pub. Date: Mar. 6, 2025

(54) BRAKE PAD ASSEMBLY WITH STRUCTURES FOR ANTI-ROTATION, RETENTION AND RETRACTION

(71) Applicant: HL MANDO CORPORATION, Gyeonggi-do (KR)

(72) Inventors: Suresh Koduri, Novi, MI (US); Robert Hill, Novi, MI (US)

(21) Appl. No.: 18/241,838

(22) Filed: Sep. 1, 2023

(51) Int. Cl. F16D 65/095; F16D 65/00; F16D 65/097

(52) U.S. Cl. CPC F16D 65/095; F16D 65/0006; F16D 65/0971

(57) ABSTRACT

A brake pad assembly comprises: a friction pad configured to be contactable with a brake rotor to apply a force to the brake rotor, the friction pad having a first recessed groove, and a back plate to which the friction pad is attached, the back plate having a second recessed groove. A footing moving the brake pad assembly has a projection passing through the second recessed groove of the back plate to limit rotational movement of the footing thereby arresting the rotational movement of a screw and a ball screw, and the first recessed groove of the friction pad is aligned with the projection of the footing and the second recessed groove of the back plate. The projection of the footing comprises a first projection part extending from the footing and a second projection part protruding from the first projection part in a direction different from a direction in which the first projection part of the projection of the footing extends.

### BACKGROUND

Various embodiments of the present disclosure generally relate to brake assemblies for a vehicle and more particularly to a brake pad assembly with structures for preventing rotation of a footing configured to move the brake pad assembly thereby achieving anti-rotation of a screw or a ball screw, retaining the brake pad assembly in position, and retracting the brake pad assembly during brake release.

An electro-mechanical brake (EMB) is a brake assembly that is actuated by electrical energy. For example, the EMB system generally provides braking of a vehicle by the use of a motor which becomes selectively energized in response to a signal of an electronic control unit (ECU) or a sensed depression of a brake input means. Generally, the EMB system may include a rotor, a brake caliper, and brake pads on opposing sides of the rotor. The brake caliper is slidably supported on pins secured to an anchor bracket fixed to a non-rotatable component of the vehicle, and includes one or more piston bores, each of which houses a piston that is movable along a piston axis during a brake apply and release of the brake apply. The brake pads are connected to one or more electrically actuated pistons for movement between a non-braking position and a braking position where the brake pads are moved into frictional engagement with the opposed braking surfaces of the rotor. For example, when an operator of the vehicle depresses a brake pedal, an actuator can move the piston into contact with one brake pad and then move one brake pad into contact with one side of the rotor, while another opposing brake pad is moved into contact with an opposing side of the rotor.

By way of example and without limitation, such an EMB system provides the desired braking in a substantially shorter amount of time than that which is provided by a conventional hydraulic braking system and allows each of the individual wheels of a vehicle or other selectively movable assembly to be selectively controlled, thereby enhancing the effectiveness of many operating strategies such as an anti-skid or anti-lock braking strategy or a strategy which is commonly referred to as an integrated vehicular dynamic strategy.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, a brake pad assembly may comprise: a friction pad configured to be contactable with a brake rotor to apply a force to the brake rotor, the friction pad having a first recessed groove; and a back plate to which the friction pad is attached, the back plate having a second recessed groove, wherein a footing configured to move the brake pad assembly has a projection passing through the second recessed groove of the back plate of the brake pad assembly to prevent rotation of the footing, and the first recessed groove of the friction pad is aligned with the projection of the footing and the second recessed groove of the back plate.

The projection of the footing passing through the second recessed groove of the back plate may comprise a first projection part extending from the footing and a second projection part protruding from the first projection part of the projection of the footing in a direction different from a direction in which the first projection part of the projection of the footing extends.

The first projection part of the projection of the footing may extend from the footing towards the brake rotor, and the second projection part of the projection of the footing may protrude from the first projection part of the projection of the footing in a direction perpendicular to a direction in which the first projection part of the projection of the footing extends.

The first projection part of the projection of the footing may extend from the footing in a direction substantially parallel to a translatable axis of the footing, and the second projection part of the projection of the footing may protrude from the first projection part of the projection of the footing in a direction substantially perpendicular to the translatable axis of the footing.

The second projection part of the projection of the footing may protrude from the first projection part of the projection of the footing in a direction substantially perpendicular to the direction in which the first projection part of the footing extends.

A part of the backing plate may be positioned between a surface of the footing facing the brake pad assembly and the second projection part of the projection of the footing protruding from the first projection part extending from the footing.

The first projection part extending from the footing, the second projection part protruding from the first projection part of the footing, and a surface of the footing facing the brake pad assembly may form a slot for accommodating a part of the back plate therein.

The first projection part extending from the footing, the second projection part protruding from the first projection part of the footing, and a surface of the footing facing the brake pad assembly may form a substantially ‘C’ or ‘U’ shape in which a part of the back plate is disposed.

A stepped part may be formed at an edge or side of the back plate, the stepped part of the back plate including a protruded portion radially protruding and a recessed portion radially recessed.

The back plate may have a stepped part including a protruded portion radially protruding and a recessed portion radially recessed, and at least a part of the protruded portion of the stepped part of the back plate may be disposed in the footing and a part of the footing is disposed in the recessed portion of the stepped part of the back plate.

The back plate may have a stepped part including a protruded portion radially protruding and a recessed portion radially recessed, and the protruded portion of the stepped part of the back plate may be positioned between a surface of the footing facing the brake pad assembly and the second projection part of the footing protruding from the first projection part extending from the footing.

At least a part of the second projection part of the footing protruding from the first projection part extending from the footing may be disposed in the recessed portion of the stepped part of the back plate.

The brake pad assembly may further comprise a shim between the back plate and the footing.

The projection of the footing comprising the first projection part extending from the footing and the second projection part protruding from the first projection part of the projection of the footing may have a letter ‘T’, ‘L’, ‘C’ or ‘U’-like shape.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a cross-sectional view of a brake assembly according to an exemplary embodiment of the present disclosure.

FIG. 2 is an enlarged view of a portion A in FIG. 1 according to an exemplary embodiment of the present disclosure.

FIG. 3 is a partial front view of a brake assembly according to an exemplary embodiment of the present disclosure.

FIG. 4 is an enlarged view of a portion B in FIG. 1 according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

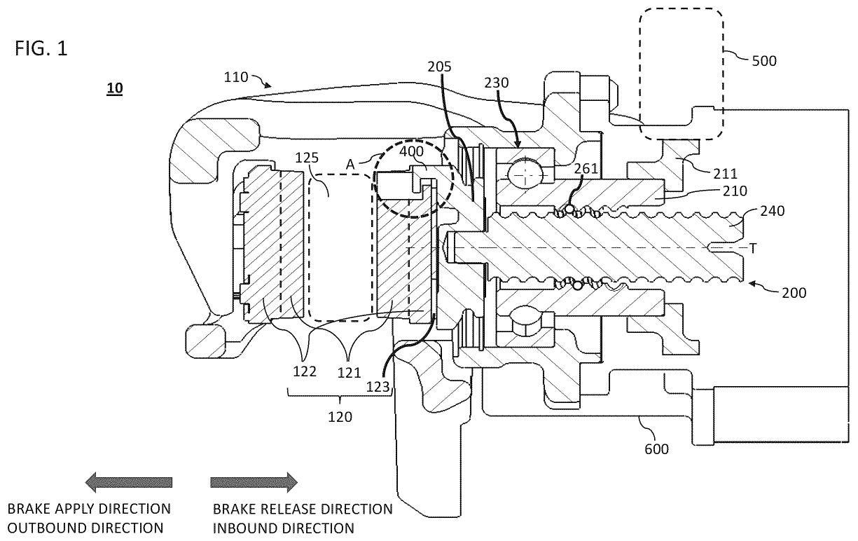

FIG. 1 is a cross-sectional view of a brake assembly according to an exemplary embodiment of the present disclosure.

Referring to FIG. 1, a brake assembly 10 may include a brake caliper 110. The brake caliper 110 may be mounted in a floating manner by means of a brake carrier. The brake caliper 110 may be connected to any non-rotating or non-moving part of a vehicle.

The brake assembly 10 may comprise a screw mechanism 200 (e.g. a ball screw mechanism or a nut-screw mechanism) configured to convert rotary motion generated by an actuator assembly 500 into linear motion in order to move brake pad assemblies (or brake lining assemblies) 120 toward or away from a brake rotor 125 in an axial direction or along a translatable axis T.

The screw mechanism 200 may include a rotatable part 210 and a translatable part 240. For example, the rotatable part 210 may comprise a nut or a ball nut and the translatable part 240 may comprise a screw or a ball screw, although not limited thereto. The screw mechanism 200 may be contained within a housing 600. The rotatable part 210 and the translatable part 240 may be concentrically mounted in a cavity formed by an inner wall of the housing 600. The housing 600 may be fixedly coupled with the brake caliper 110.

The rotatable part 210 may have a tubular shape with axially open ends, and the translatable part 240 is received within an inside space of the rotatable part 210. The rotatable part 210 and the translatable part 240 are operably connected to each other such that while the rotatable part 210 rotates, the translatable part 240 is linearly movable relative to the rotatable part 210. In other words, the translatable part 240 is slidable with respect to the rotatable part 210, but the translatable part 240 cannot be rotatable relative to the rotatable part 210, and therefore as the rotatable part 210 rotates, the translatable part 240 is linearly moved. The translatable part 240 has a structure configured to prevent the translatable part 240 from rotating relative to the rotatable part 210 while allowing the translatable part 240 to translate in the axial direction or along the translatable axis T.

At least a part of the translatable part 240 is retained within the rotatable part 210. The rotatable part 210 has an internally-threaded track groove and the translatable part 240 has an externally-threaded track groove for a rollable body arrangement of rollable bodies 261 (e.g. balls). The rollable bodies 261 are disposed between the internally-threaded track groove of the rotatable part 210 and the externally-threaded track groove of the translatable part 240. Ball returns either internally or externally carry the rollable bodies 261 from the end of their path back to the beginning to complete their recirculating track. A return tube attached to or included in the rotatable part 210 can perform recirculation of the rollable bodies 261. The internally-threaded track groove of the rotatable part 210 and the externally-threaded track groove of the translatable part 240 form a series of ball tracks to provide a helical raceway for reception of a train of recirculating the rollable bodies 261. The rollable bodies 261 may be metal spheres which decrease friction and transfer loads between adjacent components. The rotatable part 210 is rotatably supported by the translatable part 240 via the rollable bodies 261 and a bearing assembly 230. However, in alternative embodiments of the present disclosure, the rotatable part 210 and the translatable part 240 can be directly engaged with each other without the rollable bodies 261.

The bearing assembly 230 is configured to rotatably support the screw mechanism 200 for rotation of the rotatable part 210 of the screw mechanism 200 relative to a non-rotating structure of the brake assembly 10, for example, but not limited to, the housing 600. And, the bearing assembly 230 is configured to transfer the axial load of clamp force to the housing 600 to react. The bearing assembly 230 may be positioned between the rotatable part 210 of the screw mechanism 200 and the housing 600. The housing 600 may cover at least a part of the bearing assembly 230 such that the bearing assembly 230 can be seated in the non-rotating structure or housing 600. Examples of the bearing assembly 230 and other parts of the brake assembly 10 are provided in U.S. patent application Ser. No. 18/142,436, entitled “BRAKE ASSEMBLY WITH ASYMMETRICAL SHOULDER BEARING”, filed on May 2, 2023, which is incorporated herein by reference in its entirety.

The rotatable part 210 is operably coupled to the actuator assembly 500, and is configured to be rotatable by actuation of the actuator assembly 500. The rotatable part 210 is directly or indirectly coupled to the actuator assembly 500 through one or more gears and/or belts, any other connecting means and combination thereof. For example, the rotatable part 210 has a driven gear or pulley 211 which is engaged with a gear or belt of the actuator assembly 500 and is rotatable by the rotary force generated by a motor included in the actuator assembly 500. The actuator assembly 500 may comprise a motor fixedly mounted in the housing 600 or disposed outside the housing 600. Examples of the actuator assembly 500 and other parts of the brake assembly 10 are provided in U.S. patent application Ser. No. 17/575,628, entitled “BRAKE ASSEMBLY WITH TELESCOPIC MULTIPLE BALL SCREW MECHANISM”, filed on Jan. 13, 2022, which is incorporated herein by reference in its entirety.

The actuator assembly 500 rotates the rotatable part 210 of the ball-screw mechanism 200, and then the screw mechanism 200 converts the rotary motion of the rotatable part 210 to the linear motion of a brake pad footing 205 to move the brake pad assembly 120 between its brake apply and release positions. For example, the actuation of the actuator 500 causes the rotatable part 210 to rotate, and the rotation of the rotatable part 210 causes the translatable part 240 to be linearly moved. Specifically, the rotatable part 210 can rotate relative to the housing 600, and the rotation of the rotatable part 210 relative to the housing 600 causes to the translatable part 240 advance or retract axially depending on a direction of rotation of the rotatable part 210. As the rotatable part 210 rotates in an expanding direction, the translatable part 240 linearly translates with respect to the rotatable part 210 and the housing 600 so that the translatable part 240 can translate out from the rotatable part 210 and the housing 600 towards the brake rotor 125. As the rotatable part 210 rotates in a collapsing direction, the translatable part 240 linearly translates with respect to the rotatable part 210 and the housing 600 so that the translatable part 240 can linearly move toward the rotatable part 210 and the housing 600 in a direction away from the brake rotor 125. The brake pad footing 205 is fixedly coupled to the translatable part 240 so that the brake pad footing 205 can be linearly movable together with the translatable part 240. When the screw mechanism 200 is in the expanded state, the brake pad footing 205 pushes the brake pad assembly 120 toward the brake rotor 125. When the ball-screw mechanism 200 is in the collapsed state, the brake pad footing 205 moves away from the brake rotor 125.

While the expanding or collapsing direction depends upon whether the nut or ball nut of the rotatable part 210 and the screw or ball screw of the translatable part 240 are left-handed or right-handed, a specific direction is not critical to some embodiments of the present disclosure, and most embodiments of the present disclosure can work with either.

A pair of the brake pad assemblies (or brake lining assemblies) 120 is provided in the brake caliper 110, and is located on opposing sides of the brake rotor 125 that rotates with a vehicle wheel. Each brake pad assembly 120 includes a friction lining or pad (or a brake lining or pad) 121 and a back plate 122. Further, each brake pad assembly 120 may further include a shim 123. The friction pad 121 may be attached to one surface of the back plate 122 facing the brake rotor 125, and the shim 123 may be disposed on the other surface of the back plate 122 facing the brake pad footing 205.

The friction pad 121 provides a wear surface for contacting the brake rotor 125 to produce the frictional stopping force, thereby decreasing or preventing the rotary motion of the brake rotor 125. The friction pad 121 is mounted on the rotor side of the back plate 122. The back plate 122 is configured to withstand the compressive forces of the brake pad assembly 120 and shear forces caused by friction with the brake rotor 125 without substantial deformation. The back plate 122 may be formed of, for example, but not limited to, metal, such as a solid plate of steel. The back plate 122 is configured to support the friction lining 121. To dampen vibrations caused by frictional contact between the friction lining 121 and the brake rotor 125 and reduce undesired brake squeal noise produced during the braking contact, the back plate 122 may be provided with the shim 123. The shim 123 is secured to a surface of the back plate 122 opposite to the other surface of the back plate 122 to which the friction lining 121 is attached, in a position between the back plate 122 and the brake pad footing 205. The shim 123 is made of any resilient or elastic material, for instance, but not limited to, rubber, a polymeric material, Fluoroelastomer (FKM), Perfluoroelastomer (FFKM), Polychloroprene (CR), Polyisoprene (IR), Polytetrafluoroethylene (PTFE), Sanifluor, Thermoplastic elastomer (TPE) styrenics, and Thermoplastic polyurethane (TPU) polyether, polyester.

The brake pad assembly 120 is mounted to the brake pad footing 205. Although FIG. 1 illustrates the brake pad footing 205 as a separate part from the translatable part 240 of the screw mechanism 200 and fixed to the translatable part 240 such as a screw or a ball screw, the present disclosure is not limited thereto. The brake pad footing 205 can be coupled to a piston or any means configured to linearly movable in response to force generated by the actuator assembly 500. Alternatively, the brake pad footing 205 may be integrally formed with the translatable part 240, the piston or the like as a single one piece.

During the brake apply, the rotation of the nut or ball nut of the rotatable part 210 may cause the rotational movement of the screw or ball screw of the translatable part 240 which needs to be arrested in order to enable the brake pad footing 205 to move axially to generate adequate brake clamp force. A projection 400 protruding from the brake pad footing 205 and a first recessed groove 410 (e.g. a cut-portion) of the friction pad 121 and/or a second recessed groove (e.g. a cut-portion) 420 of the back plate 122 through which the projection 400 passes can prevent the rotation of the brake pad footing 205 which may be caused by the rotational movement of the nut or ball nut of the rotatable part 210 during the brake apply operation. The rotary movement of the projection 400 of the brake pad footing 205 can be limited by side walls 134 of the recessed groove 410 of the friction lining 121 and/or side walls 133 of the recessed groove 420 of the back plate 122 in order to prevent the rotation of the brake pad footing 205 thereby limiting the rotational movement of the screw or ball screw of the translatable part 240.

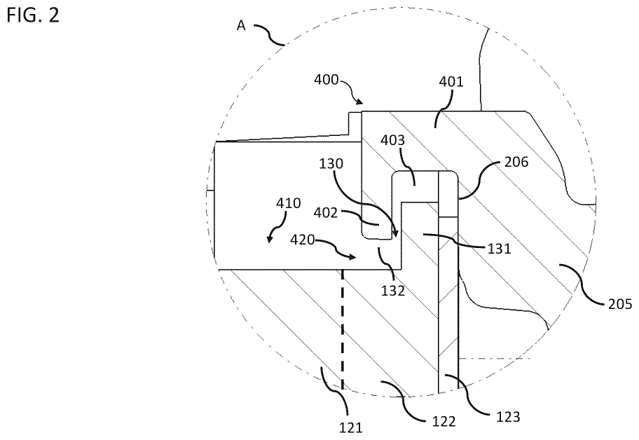

The inbound brake pad assembly 120 is attached to the brake pad footing 205, and the brake pad footing 205 is configured to linearly move the inbound brake pad assembly 120 according to the force generated by the actuator assembly 500. As illustrated in FIG. 2, the brake pad footing 205 has the projection 400 protruding from a surface of the brake pad footing 205 facing the back plate 122 or the shim 123. The projection 400 of the brake pad footing 205 passes through the second recessed groove 420 of the back plate 122 which may have a cut-out shape. The projection 400 of the brake pad footing 205 can be disposed within the second recessed groove 420 of the back plate 122 only, but may not extend to the first recessed groove 410 of the back plate 122. Alternatively, the projection 400 of the brake pad footing 205 may further extend to be within the second recessed groove 420 of the back plate 122 as well as the first groove 410 of the friction pad 121.

The projection 400 of the brake pad footing 205 may protrude from an outer edge of the brake pad footing 205 in the outboard direction of the vehicle. For example, the projection 400 of the brake pad footing 205 extends from a top portion of the brake pad footing 205 toward the brake rotor 125. However, the projection 400 of the brake pad footing 205 can be located at any position which can effectively prevent the rotation of the brake pad footing 205, such as a bottom or side portion of the brake pad footing 205. And, the projection 400 of the brake pad footing 205 may be positioned at or adjacent to the center or central portion of the width of the brake pad footing 205.

The projection 400 of the brake pad footing 205 may comprises a first projection part 401 extending from the brake pad footing 205. Additionally, the projection 400 of the brake pad footing 205 may further include a second projection part 402 protruding from the first projection part 401 of the brake pad footing 205 in a direction different from a direction in which the first projection part 401 of the brake pad footing 205 extends. For example, the projection 400 of the brake pad footing 205 may have a curved shape, a hook-like shape, a letter ‘T’-like or ‘L’-like shape, or any shape which can form an inner space or slot 403 for receiving or accommodating a part of the back plate 122 therein.

In an exemplary embodiment of the present disclosure, the first projection part 401 of the brake pad footing 205 extends from the brake pad footing 205 towards the brake rotor 125, and the second projection part 402 of the brake pad footing 205 protrudes from the first projection part 401 of the brake pad footing 205 in a direction perpendicular to a direction in which the first projection part 401 of the brake pad footing 205 extends. For example, the first projection part 401 of the brake pad footing 205 extends from the brake pad footing 205 in a direction substantially parallel to the translation axis T of the translatable part 240 or the screw mechanism 200, and the second projection part 402 of the brake pad footing 205 protrudes from the first projection part 401 of the brake pad footing 205 in a direction substantially perpendicular to the translation axis T of the translatable part 240 or the screw mechanism 200.

The second projection part 402 of the brake pad footing 205 inwardly protrudes from the first projection part 401 of the brake pad footing 205 towards the translation axis T of the translatable part 240 or the screw mechanism 200 such that a distal end of the second projection part 402 extending from the first projection part 401 of the brake pad footing 205 is positioned more inward or lower than a distal end of the back plate 205. Accordingly, a part of the second projection part 402 of the brake pad footing 205 and a part of the back plate 205 overlaps each other. Therefore, the second projection part 402 of the brake pad footing 205 can limit the axial movement of the back plate 205 by blocking a part of the back plate 20 so that the brake pad assembly 120 cannot be separated from the brake pad footing 205 and can be secured to the brake pad footing 205 during the operation of the vehicle. Further, the second projection part 402 of the brake pad footing 205 can retract the brake assembly 120 by pulling the back plate 205 during the brake release.

Because the brake pad footing 205 has the first projection part 401 of the brake pad footing 205 projecting from the brake pad footing 205 and the second projection part 402 of the brake pad footing 205 protruding from the first projection part 401 of the brake pad footing 205, an inner space or slot 403 for accommodate a part of the back plate 122 can be formed by being surrounded by the first projection part 401 and the second projection part 402 of the brake pad footing 205 and the surface 206 of the brake pad footing 205 facing the back plate 122. For example, the first projection part 40 land the second projection part 402 of the brake pad footing 205 and the surface 206 of the brake pad footing 205 facing the back plate 122 may form a substantially ‘C’ or ‘U’ shape in which a part of the back plate 122 is disposed. Accordingly, a part of the backing plate 122 is positioned between the surface 206 of the brake pad footing 205 facing the back plate 122 and the second projection part 402 of the brake pad footing 205 so that the axial movement of the back plate 122 relative to the back plate 122 can be limited within the inner space or slot 403 of the brake pad footing 205.

The back plate 122 may have a stepped part 130 on an outer edge or side of the back plate 122. The stepped part 130 of the back plate 122 includes a protruded portion 131 radially protruding and a recessed portion 132 radially recessed. A part of the protruded portion 131 of the stepped part 130 extends to the inner space or slot 403 of the brake pad footing 205 formed by the first projection part 401 and the second projection part 402 of the brake pad footing 205 and the surface 206 of the brake pad footing 205 facing the back plate 122. A part of the protruded portion 131 of the stepped part 130 can be disposed between the second projection part 402 of the brake pad footing 205 and the surface 206 of the brake pad footing 205 facing the back plate 122. And, a part of the second projection part 402 of the brake pad footing 205 is positioned in the recessed portion 132 of the stepped part 130 of the back plate 122. Therefore, a part of the protruded portion 131 of the stepped part 130 of the back plate 122 and a part of the second projection part 402 of the brake pad footing 205 can be overlapped with each other.

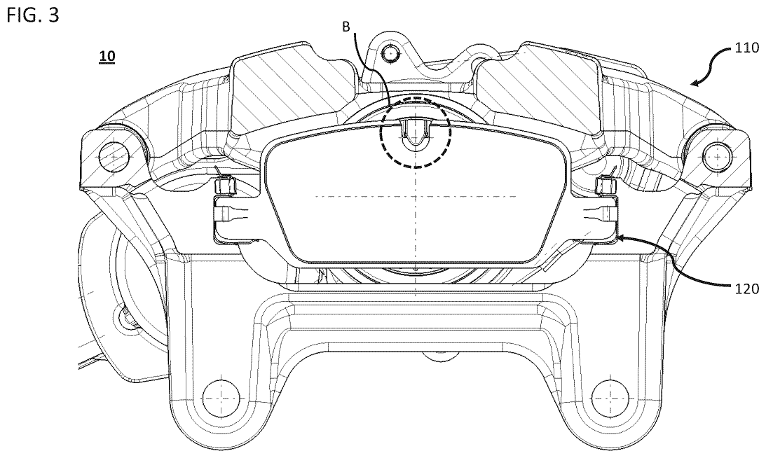

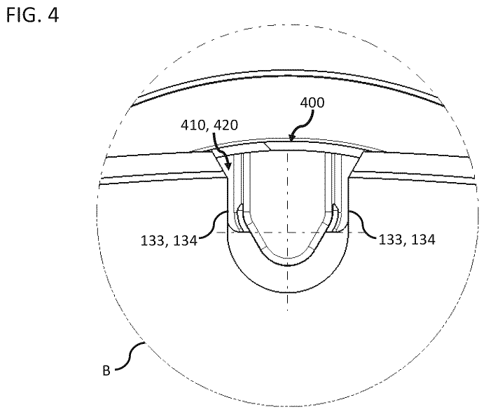

The back plate 122 has a recessed groove (or a cut-out portion) 420 to locate the projection 400 protruding from the brake pad footing 205 within the recessed groove 420 of the back plate 122. For example, the groove 420 of the back plate 122 may be recessed from neighboring normals of a surface of one edge or side of the back plate 122 (e.g. a top surface of the back plate 122, or a bottom surface of the back plate 122), and the projection 400 protruding from the brake pad footing 205 penetrates through the recessed groove 420 of the back plate 122. For example, the groove 420 of the back plate 122 may be inwardly recessed from a top surface or edge of the back plate 122. However, the recessed groove 420 of the back plate 122 can be formed at any location which can effectively limit the rotary motion of the projection 400 of the brake pad footing 205, such as a bottom surface or side portion of the back plate 122. Side walls 133 of the recessed groove 420 of the back plate 122 can limit the rotary movement of the projection 400 of the brake pad footing 205 in order to prevent the rotation of the brake pad footing 205. As illustrated in FIGS. 3 and 4, the recessed groove 420 of the back plate 122 can have a letter ‘U’-like shape. However, the recessed groove 420 of the back plate 122 is not limited to have any particular shape. The recessed groove 420 of the back plate 122 can have any shape which is capable of accommodating the projection 400 of the brake pad footing 205 therein and blocking the rotary motion of the projection 400 of the brake pad footing 205. For instance, the recessed groove 420 of the back plate 122 may be formed in a substantially ‘V’ shape, a squire, or a shape corresponding to the projection 400 of the brake pad footing 205. The recessed groove 420 of the back plate 122 may be formed at or adjacent to the center or central portion of the width of the back plate 122.

Additionally, the friction pad 121 may also have a recessed groove 410. For example, the groove 410 of the friction pad 121 may be recessed from neighboring normals of a surface of one edge or side of the friction pad 121 (e.g. a top surface of the friction pad 121, or a bottom surface of the friction pad 121). The groove 410 of the friction pad 121 may be inwardly recessed from a top surface or edge of the friction pad 121. However, the recessed groove 410 of the friction pad 121 can be formed at any location corresponding to the projection 400 of the brake pad footing 205 and/or the recessed groove 420 of the back plate 122. The recessed groove 410 of the friction pad 121 may be aligned with the projection 400 of the brake pad footing 205 and/or the recessed groove 420 of the back plate 122. In other words, the recessed groove 410 of the friction pad 121 may be located at a position corresponding to the projection 400 of the brake pad footing 205 and/or the recessed groove 420 of the back plate 122. For instance, like the recessed groove 420 of the back plate 122, the recessed groove 420 of the back plate 122 may be formed at or adjacent to the center or central portion of the width of the friction pad 121. The recessed groove 410 of the friction pad 121 may have the same shape of the recessed groove 420 of the back plate 122. However, the shape of the recessed groove 410 of the friction pad 121 may be different from that of the recessed groove 420 of the back plate 122. The recessed groove 420 of the back plate 122 can be formed in a letter ‘U’-like shape, a substantially ‘V’ shape, a squire, or a shape corresponding to the recessed groove 420 of the back plate or the projection 400 of the brake pad footing 205. The recessed groove 410 of the friction pad 121 is not limited to have any particular shape and can have any shape which can help the installation of the brake pad assembly 120 to the brake pad footing 205 and/or is capable of limiting the movement of the projection 400 of the brake pad footing 205.

And, the projection 400 of the brake pad footing 205 may pass through the recessed groove 420 of the back plate 122 only and may not penetrate into the recessed groove 410 of the friction pad 121 such that only the back plate 122 can block the movement of the projection 400 of the brake pad footing 205. However, the projection 400 of the brake pad footing 205 can extend to the recessed groove 410 of the friction pad 121 so that the projection 400 of the brake pad footing 205 can be located within the recessed groove 420 of the back plate 122 as well as the recessed groove 410 of the friction pad 121. The recessed groove 410 of the friction pad 121 can help prevent the rotary motion of the projection 400 of the brake pad footing 205. Side walls 134 of the recessed groove 410 of the friction lining 121 can limit the rotary movement of the projection 400 of the brake pad footing 205 in order to prevent the rotation of the brake pad footing 205 thereby arresting the rotational movement of the screw or ball screw of the translatable part 240. Further, the recessed groove 410 of the friction pad 121 can make easier to assemble the brake pad assembly 120 to the brake pad footing 205 by providing a space for the projection 400 of the brake pad footing 205 during the installation of the brake pad assembly 120 to the brake pad footing 205.

In addition, although the brake assembly 10 according to the embodiments illustrated in FIGS. 1 to 4 has one projection 400 of the brake pad footing 205, one recessed groove 420 of the back plate 122, and one recessed groove 410 of the friction lining 121, the brake pad footing 205 can have the plurality of projections 400 and the plurality of recessed grooves 420 of the back plate 122 and the plurality of recessed grooves 410 of the friction lining 121 which correspond to the plurality of projections 400. For instance, one of the projections 400 can extend from the top portion of the brake footing 205 and the other of the projections 400 can located at the bottom portion of the brake footing 205, one of the recessed grooves 420 of the back plate 122 can be formed at the top surface of the brake back plate 122 and the other of the recessed grooves 420 of the back plate 122 can be formed at the bottom surface of the brake back plate 122, and one of the recessed grooves 410 of the friction lining 121 can be formed at the top surface of the friction lining 121 and the other of the recessed grooves 410 of the friction lining 121 can be formed at the bottom surface of the friction lining 121.

According to some embodiments of the present disclosure, the first projection part 401 extending from the brake pad footing 205 and the recessed groove 420 of the back plate 122 and/or the recessed groove 410 of the friction pad 121 in which the first projection part 401 is disposed can limit the rotary motion of the brake pad footing 205 thereby limiting the rotational movement of the screw or ball screw of the translatable part 240. And, by having the second projection part 402 protruding from the first projection part 401 extending from the brake pad footing 205 to limit the axial movement of the back plate 122 relative to the brake pad footing 205, the separation of the brake pad assembly 120 from the brake pad footing 205 can be prevented, and the brake pad assembly 120 can be securely retracted during the operation of brake release.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake pad assembly comprising:
a friction pad configured to be contactable with a brake rotor to apply a force to the brake rotor, the friction pad having a first recessed groove; and
a back plate to which the friction pad is attached, the back plate having a second recessed groove,
wherein a footing configured to move the brake pad assembly has a projection passing through the second recessed groove of the back plate of the brake pad assembly to prevent rotation of the footing, and the first recessed groove of the friction pad is aligned with the projection of the footing and the second recessed groove of the back plate.

2. The brake pad assembly of claim 1, wherein the projection of the footing passing through the second recessed groove of the back plate comprises a first projection part extending from the footing and a second projection part protruding from the first projection part of the projection of the footing in a direction different from a direction in which the first projection part of the projection of the footing extends.

3. The brake pad assembly of claim 2, wherein the first projection part of the projection of the footing extends from the footing towards the brake rotor, and the second projection part of the projection of the footing protrudes from the first projection part of the projection of the footing in a direction perpendicular to a direction in which the first projection part of the projection of the footing extends.

4. The brake pad assembly of claim 2, wherein the first projection part of the projection of the footing extends from the footing in a direction substantially parallel to a translatable axis of the footing, and the second projection part of the projection of the footing protrudes from the first projection part of the projection of the footing in a direction substantially perpendicular to the translatable axis of the footing.

5. The brake pad assembly of claim 2, wherein the second projection part of the projection of the footing protrudes from the first projection part of the projection of the footing in a direction substantially perpendicular to the direction in which the first projection part of the footing extends.

6. The brake pad assembly of claim 2, wherein a part of the backing plate is positioned between a surface of the footing facing the brake pad assembly and the second projection part of the projection of the footing protruding from the first projection part extending from the footing.

7. The brake pad assembly of claim 2, wherein the first projection part extending from the footing, the second projection part protruding from the first projection part of the footing, and a surface of the footing facing the brake pad assembly form a slot for accommodating a part of the back plate therein.

8. The brake pad assembly of claim 2, wherein the first projection part extending from the footing, the second projection part protruding from the first projection part of the footing, and a surface of the footing facing the brake pad assembly form a substantially ‘C’ or ‘U’ shape in which a part of the back plate is disposed.

9. The brake pad assembly of claim 1, wherein a stepped part is formed at an edge or side of the back plate, the stepped part of the back plate including a protruded portion radially protruding and a recessed portion radially recessed.

10. The brake pad assembly of claim 1, wherein the back plate has a stepped part including a protruded portion radially protruding and a recessed portion radially recessed, and at least a part of the protruded portion of the stepped part of the back plate is disposed in the footing and a part of the footing is disposed in the recessed portion of the stepped part of the back plate.

11. The brake pad assembly of claim 2, wherein the back plate has a stepped part including a protruded portion radially protruding and a recessed portion radially recessed, and the protruded portion of the stepped part of the back plate is positioned between a surface of the footing facing the brake pad assembly and the second projection part of the footing protruding from the first projection part extending from the footing.

12. The brake pad assembly of claim 11, wherein at least a part of the second projection part of the footing protruding from the first projection part extending from the footing is disposed in the recessed portion of the stepped part of the back plate.

13. The brake pad assembly of claim 1, further comprising a shim between the back plate and the footing.

14. The brake pad assembly of claim 1, wherein the projection of the footing comprising the first projection part extending from the footing and the second projection part protruding from the first projection pan of the projection of the footing has a letter ‘T’, ‘L’, ‘C’ or ‘U’-like shape.
